(19) United States
(12) Patent Application Publication
(10) Pub. No.: US 2007/0183790 A1
(43) Pub. Date: Aug. 9, 2007

(54) Optical transmitter with EA-modulator

(75) Inventor: Kengo Matsumoto, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 11/654,025

(22) Filed: Jan. 17, 2007

(30) Foreign Application Priority Data
Jan. 18, 2006 (JP) 2006-010266

(51) Int. Cl. H04B 10/04

(52) U.S. Cl. 398/182

(57) ABSTRACT

The present invention is to provide an optical transmitter that includes an EA-modulator and has a function to monitor the optical output power from the EA-modulator with a simplified and small-sized circuit. The transmitter provides a semiconductor optical device integrating a laser diode with the EA-modulator, a driver, and a termination resistor. One terminal of the resistor is connected to the anode of the EA-modulator, while, the other terminal of the resistor is grounded in the AC mode. The driver is coupled in the AC mode with the terminal of the resistor and the anode of the EA-modulator via a capacitor to provide a modulation signal to the modulator. The EA-modulator is reversely biased through the resistor.

### BACKGROUND OF THE INVENTION

1. Field of the Invention

The present invention relates to an optical transmitter including a semiconductor optical device that integrally builds an optical modulator with a laser diode.

2. Related Prior Art

An optical modulator integrated with a laser diode (hereinafter denoted as LD) is often used to modulate light emitted from the LD. When the modulator has a type of the electro-absorption, such modulator is called as an EA-modulator. In such case, an optical transmitter includes a semiconductor optical device containing the LD And the EA-modulator integrated with the LD and a driver for driving the EA-modulator and the LD.

Various drivers have been known for the EA-modulator. The U.S. Pat. No. 6,044,097, has disclosed an optical transmitter in which a common cathode of the LD and the EA-modulator is grounded, while an anode of the EA-modulator is coupled with the driver in the DC mode. As shown in FIG. 3 of the '097 patent, the transmitter provides a termination resistor connected in parallel to the EA-modulator, thus, one terminal of the resistor is also grounded.

Another U.S. Pat. No. 6,882,667, has disclosed an optical transmitter in which, in an semiconductor optical device integrating a LD with an EA-modulator, a common terminal of the LD and the EA-modulator is biased by Vcm different from the ground, and both devices are oppositely driven with the bias Vcm as a reference. Moreover, the transmitter shown in the '667 patent provides a termination resistor connected in parallel to the EA-modulator and this termination resistor in one electrode thereof is connected to the bias Vcm.

When the driver is coupled with the EA-modulator and the termination resistor in the DC mode, the driver is necessary to provide not only a modulation signal but also a bias voltage to drive the EA-modulator adequately, which results in a large power supply for the driver. Moreover, because the driver is necessary to provide a photocurrent generated by the EA-modulator and another current flowing through the termination resistor, the power supply becomes large also in this viewpoint.

Accordingly, the transmitter disclosed in the '667 patent and another U.S. Pat. No. 5,706,117, prepares an additional power supply independent of the power supply for the driver. The device shown in the '117 patent has a ground terminal common to the LD and the EA-modulator. The transmitter of the '117 patent provides a resistor connected in serial to the cathode of the EA-modulator, and performs an auto-power-control (APC) of the optical output power from the device based on the photocurrent sensed by this resistor. As shown in FIG. 13 of the '117 patent, the driver of this transmitter views the termination resistor and the EA-modulator connected in parallel to the termination resistor, and one terminal of the termination resistor is grounded, which is the common to the LD and the EA-modulator.

Conventional methods for driving the EA-modulator intrinsically have several subjects, one of which is that the driver inevitably becomes a large size. In a method the bias voltage is provided to the EA-modulator superposed on the high frequency signal via a choking coil, the size of the choking coil becomes large because the signal transmitted in the public communication such as, what is called, SONET/SDH system contains relatively low frequency components in a region of scores of kilo-hertz and a large sized coil, namely, a large inductance is necessary to transmit signals containing such low frequency components in a wide range of temperatures. Thus, this method to use the choking coil is unavoidable for the driver circuit to become a large size.

Another subject appeared in conventional driving methods is that the monitoring of the output power from the EA-modulator becomes hard. In a method that a resistor is coupled to the cathode of the EA-modulator to get the optical output power, the operation of the EA-modulator becomes unstable because the bias voltage applied thereto varied in accordance with the photocurrent generated by the EA-modulator itself. In a method that the driver directly couples with the EA-modulator, the sensing, in itself, of the optical output power from the EA-modulator becomes hard, because the driver inevitably includes a termination resistor connected to the power supply Vdd for the backward signal and additional resistors to sense the photocurrent is hard to be installed.

### SUMMARY OF THE INVENTION

A feature of an optical transmitter according to the present invention is that the transmitter includes a semiconductor optical device that builds a semiconductor laser diode integrally with a semiconductor modulator with an electro-absorption type, a termination resistor, a driver for driving the modulator with a high frequency signal, and a bias source for biasing the modulator. The laser diode emits light in a continuous wave mode, while, the modulator modulates the light emitted from the laser diode with a high frequency signal output from the driver. The laser diode and the modulator have a common cathode that is preferably grounded. The termination resistor is connected to an anode of the modulator and terminates the high frequency signal which is output from the driver in an AC mode via a capacitor. In the present invention, one terminal of the termination resistor opposite to that connected to the anode of the modulator is coupled in the AC mode with the common cathode which is preferably grounded and also coupled in the DC mode with the bias source. Thus, the modulator is reversely biased by the bias source through the termination resistor.

Further feature of the present transmitter is that the transmitter provides a monitor circuit for the output of the modulator. The modulator absorbs a portion of the light emitted from the laser diode by the electro-absorption effect, and accordingly, the modulator generates a photocurrent in accordance with the absorption of the light. The photocurrent flows in the termination resistor, therefore, the monitor circuit enables to sense the optical output power from the modulator.

### BRIEF DESCRIPTION OF DRAWING

FIG. 1 is a block diagram of an optical transmitter according to an embodiment of the present invention.

### DESCRIPTION OF PREFERRED EMBODIMENTS

Next, preferred embodiments of the present invention will be described as referring to accompanying drawings. In the description of the drawings, the same numerals or symbols will refer to the same elements without overlapping explanations.

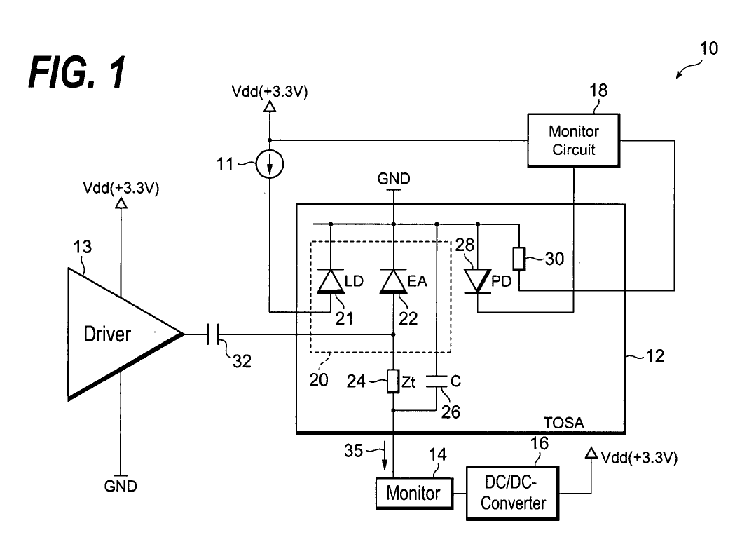

FIG. 1 is a block diagram of an optical transmitter according to an embodiment of the present invention. The optical transmitter 10 includes a transmitter optical subassembly 12, which is generally called as TOSA, and a driver circuit 13 for driving the TOSA 12. The TOSA 12 comprises a semiconductor optical device 20, a photodiode (PD) 28, and a thermistor 30.

The optical device 20 integrally builds a semiconductor laser diode (LD) 21 and an optical modulator 22 with a type of an electro-absorption, which is generally called as an EA-Modulator, on an n-type semiconductor substrate. On the back surface of the substrate is formed with a cathode electrode, which is commonly provided for the LD 21 and the EA-Modulator 22 and connected to a common terminal. In the present embodiment, the cathode electrode is grounded. Thus, the LD 21 and the EA-modulator 22 are oppositely driven with respect to the common terminal, namely, the ground terminal.

The LD 21 emits light with a continuous wave mode (CW-mode) and provides this CW light to the EA-modulator 22. The LD 21 receives a bias current from a current source 11 disposed externally from the TOSA 12. The PD 28 monitors an optical power output from the LD 21, while, the thermistor 30 monitors an ambient temperature of the LD 21. Respective outputs from the PD 28 and the thermistor 30 are sent to the monitor circuit 18 externally disposed from the TOSA 12. The monitor circuit 18 controls the magnitude of the bias current based on the output power monitored by the PD 28 and the ambient temperature sensed by the thermistor 30 so as to keep the optical output power of the LD 21 constant.

The EA-modulator 22 absorbs a portion of light emitted from the LD 21, absorbance of which is determined by a reverse bias voltage applied between the anode and cathode electrodes thereof. To apply the reverse bias voltage to the EA-modulator, the present embodiment uses a termination resistor 24 and a bias source involving a DC/DC-converter 16 that generates a negative bias voltage. The EA-modulator generates a photocurrent 35 depending on a magnitude of the absorbed light, and this photocurrent flows in the termination resistor 24. Accordingly, the DC/DC-converter supplies the bias voltage whose magnitude takes a voltage drop at the resistor 24 due to the photocurrent into consideration.

The termination resistor 24 has impedance substantially constant within a frequency range, which will be explained later, of the driving signal output from the driver 13. One electrode of the resistor 24 is connected to the anode of the EA-modulator 22, while, the other electrode thereof is grounded by a capacitor 26 that shows relatively low impedance within the frequency range.

The EA-modulator 22 is generally used in an optical communication system with a high transmission speed thereof reaching 10 Gbps. In such system like the SONET/SDH system, it is required for the driver circuit of the LD to show a preferable response within a wide frequency bandwidth from scores of kilo-hertz (kHz) to several giga-hertz (GHz). The present embodiment provides, in order to satisfy such requirement, the termination resistor 24 that is regarded to be grounded at one terminal thereof and connected in parallel to the EA-modulator 22 in high frequencies so that the impedance matching condition between the driver circuit 13 and the EA-modulator 22 can be retained.

It is preferable for the termination resistor 24, at least the terminal connected to the anode of the EA-modulator 22, to be positioned as close as possible to the anode of the EA-modulator 22 to suppress influence of the parasitic capacitance to the impedance matching condition. Similarly, one terminal of the capacitor 26 is preferable to be positioned as close as possible to the ground terminal of the termination resistor 24, and the other terminal of the capacitor 26 is also preferable to be positioned as close as possible to the cathode of the EA-modulator 22.

The ground terminal of the termination resistor 24 is also connected with the DC/DC-converter 16. Between the termination resistor 24 and the DC/DC-converter 16 is configured with a current-monitoring circuit 14. As already explained, the DC/DC-converter 16 generates a negative bias by converting the power supply Vdd. Thus, the present embodiment supplies the bias voltage of about −2 Volts to the ground terminal of the termination resistor 24.

The output of the driver 13 is provided, through a coupling capacitor 32, to a node between the EA-modulator 22 and the termination resistor 24. The driver 13 generates a high frequency signal to drive the EA-modulator 22 and supplies this signal to the anode of the EA-modulator 22. The EA-modulator modulates the light emitted from the LD 21 based in accordance with this modulation signal, thus converts the electrical signal with high frequency components into an optical signal corresponding thereto. In this state, the EA-modulator 22 in the anode thereof receives the negative bias voltage from the DC/DC-converter 16 in addition to the voltage due to the photocurrent 35 flowing in the resistor 24, which reversely biases the EA-modulator 22. Thus, the EA-modulator 22 absorbs the portion of the light emitted from the LD 21 by the absorbance determined by the bias voltage between the anode and cathode thereof.

Advantages of the present embodiment will be described below. The reverse bias voltage generated by the DC/DC-converter 16 is supplied to the EA-modulator 22 through the termination resistor 24, which makes it unnecessary to superpose the bias voltage on the transmission line for the high frequency signal, accordingly eliminates the choking coil to cut the high frequency signal. To cut the choking coil may directly result in compactness of the optical transmitter. Moreover, to provide the current monitor 14 between the termination resistor 24 and the DC/DC-converter 16 makes it possible to detect the photocurrent, which results in the monitoring of the optical output power from the EA-modulator 22.

The capacity of the DC/DC-convert 16 may be enough to provide a current whose magnitude is at least comparable to the photocurrent 35. Because the photocurrent is about 10 mA at most, the capacity of the DC/DC-converter 16 may be suppressed, which may compact the optical transmitter compact.

Moreover, the bias voltage is applied to the EA-modulator 22 via the termination resistor 24, which makes it possible for the driver 13 to be coupled with the EA-modulator in the alternating mode. Accordingly, the power supply Vdd of the driver 13 may be reduced and the power consumption of the optical transmitter 10 may be reduced.

The above descriptions and drawings are only illustrative of preferred embodiments which achieve the features and advantages of the present invention, and it is not intended that the present invention be limited thereto. Any modification of the present invention which comes within the spirit and scope of the following claims is considered part of the present invention.

What is claimed is:

1. An optical transmitter, comprising:
a semiconductor optical device that builds a semiconductor laser diode integrally with a semiconductor modulator with an electro-absorption type, a cathode of the laser diode and a cathode of the modulator commonly connected;
a termination resistor with first and second terminals, the first terminal being connected to an anode of the modulator and the second terminal being connected to the cathode of the laser diode in an AC mode;
a driver connected to the anode of the modulator in the AC mode to provide a modulation signal to the modulator; and
a bias source connected to the second terminal of the resistor,
wherein the modulator is reversely biased by the bias source through the resistor.

2. The driver according to claim 1,
further comprising a monitor circuit connected between the second terminal of the modulator and the bias source to monitor an optical output power from the modulator.

3. The driver according to claim 1,
wherein the cathode of the laser diode and the cathode of the modulator are commonly grounded, and
wherein the second terminal of the resistor is grounded in the AC mode by a capacitor.
